(19) United States
(12) Patent Application Publication
(10) Pub. No.: US 2002/0197387 A1
(43) Pub. Date: Dec. 26, 2002

(54) Apparatus and method for producing particles from a food material, in particular a chocolate material

(76) Inventors: Wolfgang Tilz, Schwetzingen (DE); Lars Schnoor, Heidelberg (DE)

Correspondence Address: MARSHALL, GERSTEIN & BORUN, 6300 SEARS TOWER, 233 SOUTH WACKER, CHICAGO, IL, 60606-6357, US

(21) Appl. No.: 10/076,988

(22) Filed: Feb. 15, 2002

(30) Foreign Application Priority Data
Feb. 15, 2001 (DE) 101 07 124.8

(51) Int. Cl. A23G 3/00

(52) U.S. Cl. 426/660

(57) ABSTRACT

Described is an apparatus and a method for producing particles from a food material, in particular a chocolate material. The material is heated with a melting device up to flowability and supplied to a shaping device which includes at least one nozzle for dripping the flowable material as well as a cooling device for solidifying the material drops in particle form. To make such an apparatus and such a method more efficient in a constructionally simple way, it is suggested that the cooling device should contain a cooled contact surface which is movable relative to the nozzle.

The present invention relates to an apparatus and a method for producing particles from a food material, in particular a chocolate material, of the type explained in the preambles of claims 1 and 14.

Such an apparatus and method are known from EP 976 333. The known apparatus contains a downpipe which is arranged with a vertical central axis and in the upper portion of which a dripping device is arranged for the flowable chocolate material. The dripping device includes a nozzle block which substantially covers the cross section of the downpipe and consists of a plurality of individual dripping nozzles from which material drops exit and freely fall through the downpipe. The nozzle block is heated to prevent chocolate material from solidifying already during the dripping process and from clogging the nozzles. A cooled gas, preferably nitrogen, is used as the sole coolant. The nitrogen should have a temperature of at least −60° C., preferably −160° C. when introduced and −80° C. when leaving the downpipe. Nevertheless, this still requires a downpipe length of a total of about 20 m. The coolant is preferably passed in countercurrent fashion relative to the fall path of the drops and leaves the downpipe in the area of the nozzle block. It can thus not be avoided that the heated nozzle block also comes into contact with the coolant. In the most advantageous case this results in waste of energy and in the most disadvantageous case chocolate material may already harden in the area of the nozzles and thus clog the nozzles.

If in the case of the known apparatus the shape of the particles to be produced thereby is to be varied, this must be carried out in a rather troublesome way by a correspondingly changed gas guidance of the coolant in order to produce a specific turbulence of the gas that will yield the desired result. This turbulence is preferably achieved by a tangential inflow of the gas, whereby a twist component is to be produced in the pipe flow; i.e., by a constructionally entirely different solution which requires a separate downpipe.

Thus, it is the object of the present invention to provide an apparatus and a method with which particles can be produced from a food material, in particular a chocolate material, in a way that is simple constructionally and with respect to process engineering.

The object is achieved by an apparatus according to claim 1 and by a method according to claim 14.

The use of a cooled contact surface which is movable relative to the nozzle and is used for cooling the material drops quite decisively reduces the risk that the material drops already freeze when leaving the nozzle, thereby causing failure. It has further been found that a bursting of the material drops upon impingement on a fixed surface as feared in EP 976 333 is at least not observed when, as suggested in the present invention, the contact surface is cooled and moves relative to the nozzle or the drops.

Preferably, the contact surface according to claim 2 is the circumferential surface of a rotatingly driven cooling roller, but it would also be possible to use e.g. a shaking chute or to move a movable nozzle over a stationary contact surface.

The scraper described in claim 3 facilitates the removal of the cooled particles from the contact surface.

Claim 4 describes an apparatus which is particularly simple under constructional aspects, the material drops passing under the action of gravity onto the contact surface.

Of particular advantage is the design according to claim 5, wherein the particle shape is definable by changing the distance between the contact surface and the nozzle. For instance, it is possible to produce rather chip-like particles by reducing the distance between the contact surface and the nozzle, whereas an enlarged distance rather yields spherical particles.

The present invention is particularly suited for producing sterile particles, as are added to microbially sensitive products, such as dairy products, because both the nozzle and the contact surface according to claim 7 can be jointly accommodated in a shaping container which is to be kept in a sterile state and may be further developed according to claims 8 to 10.

Although EP 974 275 discloses a method for sterilizing food materials, in particular chocolate, it does not describe any possibility of shaping particles from said material without contamination. In the known method, the material, in particular chocolate, is brought in a solid state into a closed double-jacket pressure tank and there heated with the help of the jacket heater to about 80° C. until the material becomes flowable. Direct steam is then introduced for heating the material to a sterilization temperature of 125° C. The jacket heater remains active, but is probably rather intended to prevent heat losses. The sterilization pressure is about 3 bar, absolute. The material is kept at the elevated temperature for a predetermined period of time and a vacuum is subsequently applied for evaporating the undesired water introduced by the steam into the material and for cooling the chocolate to about 60° C. The flowable chocolate is then pumped into a reservoir. The further processing is not described. The heating of the material to the sterilization temperature using direct steam has, however, the drawback, as can also be learnt from the description of the known method, that an excessively large amount of water is introduced into the material, which is particularly undesired for chocolate, and must be removed again, which complicates the method.

According to claim 11 the sterilization device is arranged in the present invention between a melting device and the shaping container, so that the material passes in an already homogeneously flowable and thoroughly mixed state into the sterilization apparatus.

Suitably, the sterilization device according to claim 12 includes a container with a heatable and coolable double jacket so that the material can be brought by direct contact with the heated double jacket to sterilization temperature and/or can be cooled down by direct contact with the cooled double jacket from the sterilization temperature to the further processing temperature.

Suitably, a heatable storage tank which can provide a sufficient supply of flowable material for feeding the intermittently operating sterilization device is arranged between the melting device and the sterilization device according to claim 13.

The present invention further relates to a method according to claim 14 and further developments of the method according to claims 15 to 21.

An embodiment of the invention shall now be explained in more detail with reference to the drawings, in which:

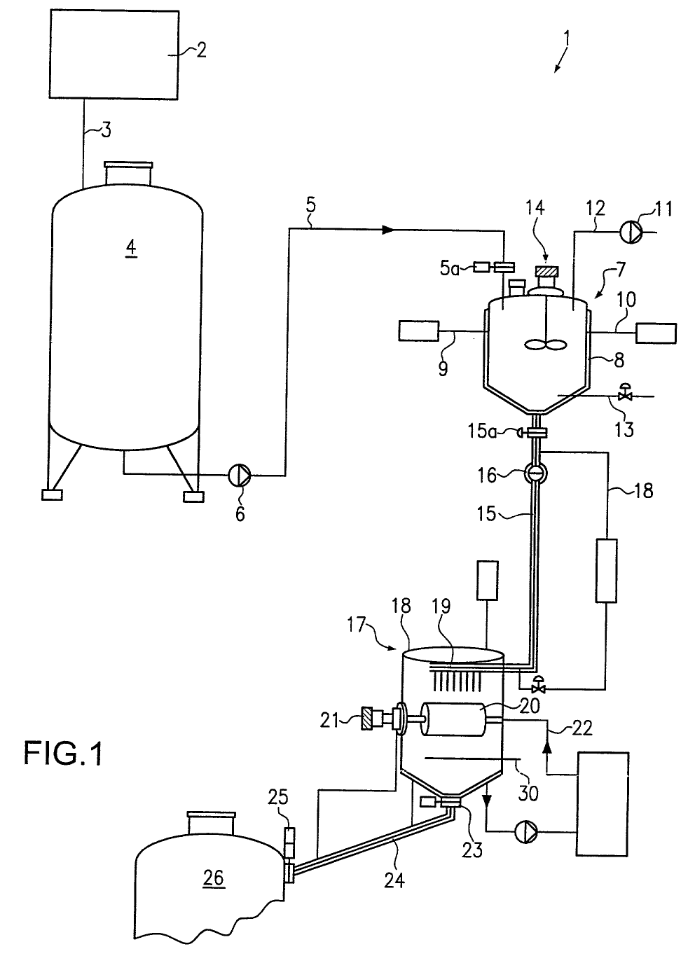

FIG. 1 is a schematic view of an apparatus according to the invention for carrying out the method according to the invention; and

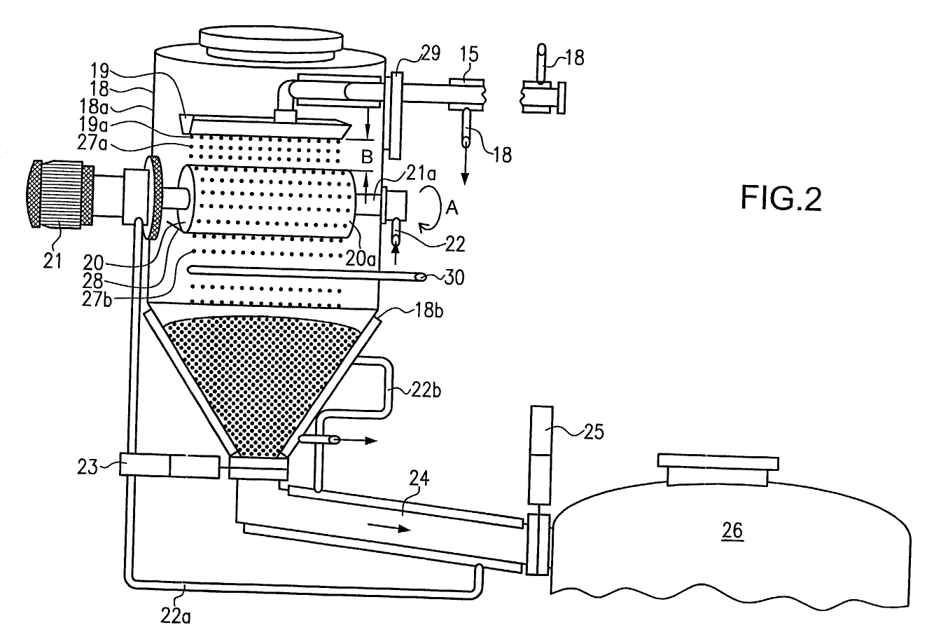

FIG. 2 is a schematic enlarged view of a shaping container.

FIG. 1 is a schematic illustration showing the most essential components of an apparatus 1 for producing particles from a food material and, in particular, an apparatus for producing sterile particles from said food material. The food material may be any material that is solid at a consumption temperature, in particular at room temperature, and can be molten into a flowable state by raising the temperature, i.e. in particular cocoa-containing materials or materials containing cocoa components, preferably chocolate materials.

In the direction of the progressive processing of the materials, the apparatus 1 comprises a heating device 2 in which the material is heated to such an extent that it becomes flowable; in the case of chocolate materials, the temperature required therefor ranges from about 40° C. to about 80° C. The heating device need not necessarily be integrated into the process line; the material may also be delivered by a supplier in a state in which it is already ready for processing. Said flowable heated material is passed via a line 3 into a storage tank 4 which is insulated and provided with a heating means of its own. In said storage tank 4, the material is kept in a flowable state, i.e. between 40° C. and 80° C., preferably 60° C., in the case of chocolate material. A line 5 with a shut-off device 5a leads from said storage tank 4 via a suitable pump 6, preferably a gear pump, into a sterilization device 7. The sterilization device 7 includes a double-walled, pressure-tight and closed container 8 whose double wall is connected to a heating circuit 9 for a heating medium, in particular steam or superheated water, and to a cooling circuit 10 for a cooling medium, in particular cold water. A gas line 12 which is provided with a pump 11 and via which the sterile and/or inert gas, such as sterile air or nitrogen, can be introduced into the upper portion of the container 8 and via which a vacuum can be produced in the container 8 with the help of pump 11 terminates in the interior of the sterilization container 8. Finally, a steam connection 13 terminates in the interior of the container 8.

The interior of the container 8 has arranged therein one of the standard mixers 14 that is capable of continuously circulating the whole material positioned inside the container 8 and, in particular, of protecting the same against an excessively long action by the heated container wall. The mixer 14 is preferably designed as a stirrer with a scraper assigned thereto.

The flowable material is conveyed by the pump 6 via line 5 and shut-off device 5a in a predetermined amount into the container 8. The mixer 14 is running and the wall of the container 8 is heated via the steam circuit 9 to a temperature which can heat the material in the interior of the container 8 to a sterilization temperature between about 110° C. and about 140° C. for killing all viable germs. The material in container 8 is over-coated with sterile air or nitrogen via line 12 and pump 11, so that a pressure of about 2.5 bar is built up. When the material in the container 8 has reached a temperature of about 100° C., so that substantial condensation need no longer be expected, direct steam may additionally be added via line 13 to enhance the killing effect. When the necessary sterilization temperature has been reached, it is maintained for a predetermined period of time, preferably between 4 to 10 minutes.

Subsequently, pressure is relieved and, if necessary, the added water is removed, the container being subjected to a vacuum, preferably via pump 11. The container is cooled down by supplying cold water via cooling circuit 10 into the double jacket to such an extent that the material inside the container assumes a temperature at which it is just flowable; in the case of chocolate material this is about 20° C. to about 40° C. Subsequently, the material is kept at said temperature, again by supplying a heating medium via the heating circuit 9, the heating medium being optionally mixed with a cooling medium via cooling circuit 10.

Instead of the double jacket of the container, the sterilization operation may also be performed by heating up the material by means of a microwave or high-frequency technique, as is known per se. As an alternative to the double jacket, other known heat exchangers, such as scraper or tubular heat exchangers, may be used; a uniform heating must here be ensured without the foodstuff being separated into its components. Heating in tubes with adequate turbulence by suitable mixers or a high pumping capacity yields the best results. Even if the material is heated by other sources of heat, a cooling by the double jacket of the container 8 may nevertheless take place.

The sterilization container 8 is connected to a shaping device 17 via a double-walled heatable discharge line 15 in which a suitable shut-off device 15a and optionally a pump 16 are arranged. The discharge line 15 is supplied via a heating circuit 18 with a heating medium, so that the material in the discharge line 15 can be kept at the desired temperature at which the material is just flowable, i.e. in the case of chocolate materials between about 25° C. and about 30° C.

The shaping device 17 will be described in the following in more detail with reference to FIG. 2; it also includes a closed container 18 which has arranged therein a dripping device 19 and a horizontally oriented cooling roller 20 which is vertically positioned thereunder at a distance. The cooling roller 20 is rotatingly driven by a motor 21 comprising a drive shaft 21a and communicates with a coolant circuit 22 for cooling brine. In the lower portion of the container 18, a coolable outlet line 24 is connected via a shut-off device 23 and communicates via a further shut-off device 25 with a reservoir 26 (Oust sketched) for the chocolate particles. The shut-off devices 23 and 25 act as gates for maintaining sterile conditions in the container 18.

As shown in FIG. 2, the shaping container 18 includes an upper cylindrical portion 18a and a hopper-like portion 18b positioned thereunder in the direction of gravitational force. The upper cylindrical portion 18a has arranged therein the dripping device 19 which contains at least one nozzle 19a. Preferably, the dripping device 19 is designed as a heatable nozzle block and comprises a plurality of nozzles which are preferably equally spaced apart from one another and which are arranged in the same horizontal plane and preferably side by side in rows in parallel with one another and with the drive shaft 21a, and which are oriented towards the apex line of the cooling roller 20.

The cooling roller 20 is rotatingly drivable by the drive shaft 21a of the motor 21 in the direction of arrow A at a controllable speed. The drive shaft 21a extends in sterile fashion through the container wall and is supported via sliding shaft seals and condensation locks on the container wall, resulting in aseptic conditions. The drive includes a frequency converter which is pre-mounted together with the cooling roller 20 on a flange and serves the fine adjustment of the roller rotation to the dripping speed.

The drive shaft 21a is arranged such that the circumferential surface 20a in the apex point of the cooling roller 20 is arranged at a distance B below the nozzles 19a of the dripping device 19. Thus the distance B defines the shortest path of free fall the material drops 27a exiting from the nozzles 19a or pressed out under pressure must travel before they impinge on the circumferential surface 20a of the cooling roller 20, which is designed as a contact surface

The cooling roller 20 has assigned thereto a stripping device 28 in the form of a scraper, or the like, which strips off the solidified material drops from the contact surface 20 and makes them drop as solid particles 27b into the hopper-like part 18b of the container 18 which is configured as a storage area.

The distance B between the contact surface 20a and the nozzle 19 can be adjusted, preferably via an adjustable flange 29 which holds the dripping device 19 on the container 18. As a result, it is possible to define and change the free fall of the material drops 27a and thus, in combination with the temperature of the material upon exit from the nozzles 19a, the shape of the solid particles 27b.

The roller 20 is supplied via the coolant circuit 22, which is shown in more detail in FIG. 1, with cooling brine of −20° C. via the hollow-shaped drive shaft 21, the cooling brine being again discharged at the motor side. The line 24 is connected via line 22a into the coolant circuit 22, and the hopper-like part 18b of the shaping container 18 which forms the storage portion is connected via a line 22b. A further coolant line 30 terminates in the cylindrical part 18a of the shaping container 18, whereby coolant can be introduced at a relatively low temperature, preferably nitrogen, into the shaping container 18 to accelerate the cooling action so as to achieve a complete and thorough cooling of the particles and to avoid any heating up. The coolant line 30 extends in the form of a kind of cooling lance with a plurality of exit openings in parallel with the drive shaft 21a and, laterally below the cooling roller 20, into the container 18 and over the total axial length of the cooling roller 20.

If a sterilized amount of material is contained in the sterilization container 7, and if solid particles 27b are to be shaped, flowable material which in the case of chocolate material has a temperature of 25° C. to 30° C. is conveyed either continuously or discontinuously by the pump 16 via line 15 into the dripping device 19. The cooling roller 20 is rotatingly driven by the motor 21 and supplied with coolant via the cooling circuit 22. Optionally, coolant is additionally introduced into the container via line 30.

The material drops 27a which are dripping out of the nozzles 19a have already been cooled in a free fall over distance B and then fall on the contact surface 20 which moves in a direction transverse to the direction of fall or movement of the material drops 27a and is strongly cooled (in the case of chocolate material to −20° C.); on said contact surface they are rapidly cooled down so that they at least maintain their shape. The material drops arriving in the area of the stripping device 28 are thus already solid particles which are stripped off by the stripping device 28 from the contact surface 20a and fall into the hopper-like part 18b which is also cooled to avoid any heating up. When the shut-off device 23 is opened, the particles will fall into line 24, which is designed as a chute, to the second shut-off device 25. The first shut-off device 23 can be closed again before the second shut-off device 25 is opened, so that the shut-off devices 23 and 25 act as a kind of gate which keeps the interior of the shaping container 18 in an aseptic state. The finished particles can then be stored in a suitable reservoir 26.

Steam pipes, or the like, may be connected to all components of the apparatus according to the invention for sterilizing the whole facility from time to time.

It should further be noted that both the coolant and the heating means are each circulated to save energy in this way.

In a modification of the embodiments which have been described and depicted, the shaping device can also be used for processing non-sterilized materials. The contact surface may be designed as a shaking chute, or the like. The storage area in the lower part of the shaping container can be omitted, especially when a continuous discharge of the solid particles is guaranteed. The temperatures can be selected in response to the characteristics and sensitivity of the processed materials. The special cooling and heating means can also be replaced by others. Instead of the slides shown in the drawings, it is possible to use other suitable shut-off devices; in particular, the shut-off device which seals off the shaping container may be a metering valve. Instead of being sprayed over a fall path, the material drops may also be sprayed onto a contact surface which is optionally arranged in vertical direction.

1. An apparatus (1) for producing particles (27b) from a food material, in particular a chocolate material, comprising a melting device (2) for heating the material up to flowability, and a shaping device (17) which includes at least one nozzle (19a) for dripping the flowable material, as well as a cooling device (20) for solidifying said material drops (27a) in particle form (27b), characterized in that said cooling device contains a cooled contact surface (20a) which is movable relative to said nozzle (19a).

2. The apparatus according to claim 1, characterized in that said contact surface (20a) is the circumferential surface of a rotatingly driven cooling roller (20).

3. The apparatus according to claim 1 or 2, characterized in that said moving contact surface (20a) has assigned thereto a stripping device (28) for removing said particles (27b) from said contact surface (20a).

4. The apparatus according to any one of claims 1 to 3, characterized in that said nozzle (19a) is arranged substantially in vertical direction and at a distance (B) above said cooled contact surface (20a).

5. The apparatus according to claim 4, characterized in that said distance (B) is adjustable between said nozzle (19a) and said contact surface (20a).

6. The apparatus according to any one of claims 1 to 5, characterized in that said cooling device additionally contains a gaseous coolant.

7. The apparatus according to any one of claims 1 to 6, characterized in that a shaping container (18) in which said nozzle (19a) and said contact surface (20a) are arranged is provided for producing sterile particles (27b).

8. The apparatus according to claim 7, characterized in that said shaping container (18) includes a storage area (18b) for said particles (27b).

9. The apparatus according to claim 8, characterized in that said storage area (18b) can be cooled.

10. The apparatus according to any one of claims 7 to 9, characterized in that said shaping container (18) comprises a cooled discharge line (24) which is provided with a gate (23, 25) for discharging said particles (27b).

11. The apparatus according to any one of claims 7 to 10, characterized in that a sterilization device (7) is arranged between said melting device (2) and said shaping container (18).

12. The apparatus according to claim 11, characterized in that said sterilization device (7) comprises a container (8) with a double jacket designed as a heat exchanger.

13. The apparatus according to claim 11 or 12, characterized in that a heatable storage tank (3) is arranged between said melting device (2) and said sterilization device (7) for temporarily storing flowable material.

14. A method for producing particles (27b) from a food material, in particular a chocolate material, the material being heated up to flowability, dripped, and cooled in particle form, characterized in that for cooling purposes said material drops (27a) are applied to a cooled contact surface (20a) which moves relative to said material drops (27a).

15. The method according to claim 14, characterized in that said material drops (27a) are applied by way of a free fall onto said contact surface (20a), and that the length of the path of fall can be varied.

16. The method according to claim 14 or 15, characterized in that said material drops (27a) are additionally cooled by a gaseous cooling medium.

17. The method according to any one of claims 14 to 16, characterized in that said material is first sterilized for producing sterile particles (27b) and is subsequently dripped and cooled in a closed chamber (18).

18. The method according to claim 17, characterized in that said material is brought to a sterilization temperature by heating on a heated surface.

19. The method according to claim 18, characterized in that said material is over-coated with a sterile gas at an elevated pressure during sterilization.

20. The method according to claim 18 or 19, characterized in that steam is additionally introduced into said material for sterilization as soon as said material had reached a predetermined elevated temperature, preferably about 100° C.

21. The method according to any one of claims 14 to 20, characterized by a multi-stage temperature control, wherein said material is first heated to become flowable, in the case of a chocolate material to about 40° C. to about 80° C., then conveyed for sterilization, subsequently heated to sterilization temperature, preferably between about 110° C. and about 140° C., subsequently cooled down to a still flowable temperature, in the case of chocolate material down to about 20° C. to about 40° C., and is conveyed at said temperature for dripping.
